(19) United States
(12) Patent Application Publication
(10) Pub. No.: US 2024/0062323 A1
(43) Pub. Date: Feb. 22, 2024

(54) SYSTEM METHOD AND COMPUTER READABLE MEDIUM FOR MODERATED DISCUSSION AND RESOLUTION OF DISPUTES

(71) Applicant: Lee Edward Kelly, III, Decator, GA (US)

(72) Inventor: Lee Edward Kelly, III, Decator, GA (US)

(21) Appl. No.: 18/233,388

(22) Filed: Aug. 14, 2023

Related U.S. Application Data
(60) Provisional application No. 63/399,683, filed on Aug. 20, 2022.

(51) Int. Cl. G06Q 50/18; G06Q 50/00

(52) U.S. Cl. CPC G06Q 50/18; G06Q 50/01

(57) ABSTRACT

A system and method for moderating and facilitating a resolution to disagreements and disputes between individuals on a set of facts comprising, an online platform with a courtroom and judge accepting inputs from defined users of the platform who have specific disagreements on a subject matter and promoting an open and fair discussion between the parties to find a resolution to their disagreements. The system and method of the platform allows intervention and assistance by invited third parties to help the fact creator or one or more challengers disputing the set of facts, to establish whether the statements of facts made by the fact creator are true or false. Cases are settled either by way of one of the parties to the dispute conceding, or by having the judge decide the veracity of the facts presented by the fact creator.

### CROSS-REFERENCE TO RELATED APPLICATION

This application claims priority under 35 USC 119 (e) to U.S. Provisional Patent Application Ser. No. 63/399,683 filed, Aug. 20, 2022 which is incorporated herein by reference, in its entirety.

### FIELD OF THE INVENTION

The present invention generally relates to communications between individuals on a social media, or other similar platforms. More specifically, the invention relates to an online platform that facilitates resolution of disagreements and disputes between one or more individuals on a set of facts propounded by those individuals.

### BACKGROUND OF THE INVENTION

Disagreements and conflicts, particularly among users of social media platforms are common, and generally get settled between the parties involved in the discourse. However, on occasion, such disagreements and conflicts can lead to either party getting frustrated with the other in not being able to resolve the issues upon which they have a disagreement. Many of these disagreements and conflicts arise when the parties do not agree on a common set of facts or assertions that support their opinions and stances on a subject. As a result, online discourse especially on social media platforms has become more hostile and less productive, as users of such platforms may elect not to participate or engage in online activities because neither party is willing to concede and resolve their differences of opinions on a set of facts, negating the intended communal benefits of such online platforms.

The present invention is an online platform for facilitating a discussion between parties who are in disagreement with each other over a set of facts. The system and method of the invention provides a resolution to the party's disagreements via a fact courtroom that moderates discussions with automated regulations, opponents enforcing courtroom rules on one another, a referee, and a judge representing a “Fact Court.”

### BRIEF SUMMARY OF THE INVENTION

In the exemplary embodiment of the present invention, the online platform for facilitating a resolution to disagreements and disputes between parties on a set of facts comprises a system, method and a computer-implemented process. In embodiments of the invention, the method includes accepting inputs from defined users of the platform who have specific disagreements on a subject matter and promoting an open and fair discussion between the parties to find a resolution to their disagreements using a system comprised of a judge, a referee, sets of rules, and a fact courtroom consisting of functionality that enables focused debates (hereinafter “referee,” “judge” and “fact court”) that provides a fair and amicable resolution to the conflict and disagreements between the parties. In this embodiment of the invention, the debaters, the referee, the judge, along with intervention by third parties in some cases, evaluate and decide on the veracity or falsehood of the facts presented by the fact creator to establish whether the statements of facts made by the fact creator are true or false.

In embodiments of the invention, the user referred to generally as the fact creator or argument creator presenting the facts, accesses the online platform of the invention through a computer-generated page on their desk top, lap top, smart phone or other smart device, and using the input field provided by the platform, enters certain facts, statements, or assertions which the user believes is true, and the justification for the facts being true, with supporting evidence. The system of the invention then generates a courtroom web page and publishes the user-generated fact, statement, or assertion on the courtroom web page, which is stored in a searchable fact library/database for purposes of facilitating the engagement of other users of the platform, or sharing the webpage through the users of other social media platforms, websites, apps, or programs.

In embodiments of the invention, the system generates a field for the user/fact creator or third parties to invite other users to participate as challengers in the courtroom webpage. The system then generates emails or other electronic messages to inform the parties of their invitation to participate in the courtroom webpage discussion. The system generates a number of tabs or fields on the courtroom webpage for multiple challengers to begin parallel discussions over the veracity or falsehood of the user-generated fact, statement, or assertion. In this embodiment, if a challenger has entered a response, the system generates a response field for the fact-creator. The system will continue this process, generating response fields—including uploaded evidence—as each opposing user/challenger enters a response and continues the discussion on the courtroom webpage. The system may also generate a button to allow a third party to request to intervene in the discussion on behalf of the fact-creator or challenger(s).

In some embodiments of the invention, there is a Prove It button to challenge the statements or facts made by the fact creator, the challenger and/or third parties if they are provable. The Prove it button may also be made available for public viewing by all third-party viewers of the courtroom webpage discussions. The system may then generate a new courtroom webpage for the sub-argument or sub-discussion of the fact for which proof was requested. The system may also generate links between the original courtroom webpage and the sub-argument courtroom webpage to facilitate movement of users and viewers between the courtroom webpages.

Other features of the platform of the invention include buttons for Object with Rules, Ask a Question, Call a Ref, Call a Friend, Concede, Call a Judge to receive assistance from these sources as necessary for facilitation of the courtroom webpage discussion. Object with Rules enables a debater to object to his/her opponent's rebuttal based on a list of courtroom rules. If the party facing the objection or the referee confirms the objection, the party facing the objection will be compelled to provide a different rebuttal. Call a Friend enables debaters to seek help from others in giving a rebuttal by way of selecting friends they want to call and discussing possible replies with them. Ask a Question allows the two opponents to have a sidebar discussion separate from their formal replies. Call a Ref enables the two debaters to have a referee intervene at any time to resolve disputes and enforce rules. The referee is the one who yields ultimate power in the courtroom. If the Call a Judge button is pressed and agreed to by both parties, the two opponents agree to end their debate, and the system will send a message to the judge to review the dispute or discussion, and rule who won the case, if anyone. The system will also generate a field for the input of the judge's decision, including any supporting documents, evidence, or reasoning provided by the judge. The system will then receive the judge's comments and decision on the summary and publish the judge-approved summary resolution to any questions raised by the various stakeholders. Embodiments of the invention also allow an Appeal of the Judge's decision.

### BRIEF DESCRIPTION OF THE DRAWINGS

FIGS. 1-14 provide flow diagrams of the processes involved in the online platform of the present invention to facilitate a fair and equitable resolution to the disagreements and/or disputes between opposing parties. The platform of the invention provides for a referee, judge and a courtroom that is the Fact Court (fact court) to accomplish this goal. If neither of the two debaters concede the case via the Concede button/function, the judge presiding over the fact court evaluates and decides on the veracity or falsehood of the facts presented by the parties to arrive at a conclusion as to whether the statements made by the parties are true or false. In embodiments of the invention, a third party is allowed to discuss rebuttal strategies with either debater, and in other embodiments third parties would intervene on behalf of the fact creator or challenger of the facts set forth by the fact creator, and actually reply on his or her behalf.

FIG. 1 is a schematic diagram illustrating the general architecture and set up of the online platform of the present invention showing the interactions of the fact courtroom, comprising a referee, judge and the various stakeholders involved in the dispute, aimed at finding a resolution to the disagreements and disputes between the parties.

FIG. 2 is a flow diagram describing the initial step of a user logging into the online platform of the invention by means of a graphical user interface of a computer system whether it be a desk top computer, tablet, smart phone, or other smart device connected to the platform through the internet and providing input by the user/fact creator of a fact or set off facts, statements, or assertions. It shows the process of creating a fact or argument.

FIG. 3 is a flow diagram showing the next step of providing the user/fact creator with options to upload files, descriptions, to support the user's facts, statements, or assertions and generate a courtroom for trial of the user generated facts, statements, or assertions and allow and invite challengers to dispute the user's facts, statements, or assertions.

FIG. 4 is a flow diagram describing how each challenger tab on the courtroom webpage works, so that challengers can begin parallel discussions over the veracity or falsehood of the user-generated fact, statement, or assertion.

FIG. 5 is a flow diagram describing the steps to enable a third party to assist in giving a rebuttal to his/her opponent, by way of clicking the Help Answer button.

FIG. 6 is a flow diagram describing the Prove It function, and the generation of a new courtroom webpage for a sub-argument or sub-discussion of the fact for which proof was requested by the opponent, with links generated between the original courtroom webpage and the sub-argument courtroom webpage to facilitate movement of users and viewers between the two courtroom webpages.

FIG. 7 is a flow diagram describing the Object with Rules function, where each debater can challenge the most recent statement made by his/her opponent. Embodiments include a drop-down list of objections that can be made. The person being challenged has to agree or disagree with the challenge. A referee will be called to intervene if the two debaters cannot resolve the issue.

FIG. 8 is a flow diagram describing the process of allowing a debater to ask a question to his/her opponent and publish the question to the Ask a Question button pop-up page in courtroom for discussion.

FIG. 9 is a flow diagram describing the process of calling a friend as a third party by the fact creator or the challenger to discuss the opponent's rebuttal and formulate a response. Call A Friend allows the debater to call either specific friends, or all friends. Then, the debater and the called friends can discuss the rebuttal at hand in a group chat. In other embodiments, the friend could take control from the debater and submit replies on his or her behalf.

FIG. 10 is a flow diagram describing the process of Call a Ref, where either party can call for a referee to come to the current rebuttal box and resolve a dispute via multi-person chat functionality.

FIG. 11 is a flow diagram describing the process of Call a Judge, where either party can call for a judge to resolve the entire argument/case if neither party voluntarily concedes the case. The judge will review all the arguments and evidence and arrive at a decision about who won the argument, if anyone.

FIG. 12 is a flow diagram describing the process of Concede, where one of the two debaters voluntarily concedes the case. Once the loser concedes, the winner writes a case summary, which must be approved as being correct by the loser. A referee can be called if the two debaters cannot agree on the case summary. This procedure is also explained in FIG. 10 and FIG. 11.

FIG. 13 is a flow diagram describing the appeal process following the judge's decision and whether the judge grants or denies the appeal by the losing party.

FIG. 14 is a flow diagram describing the Upload Evidence process that takes place when facts/arguments are first created.

### DETAILED DESCRIPTION OF THE INVENTION

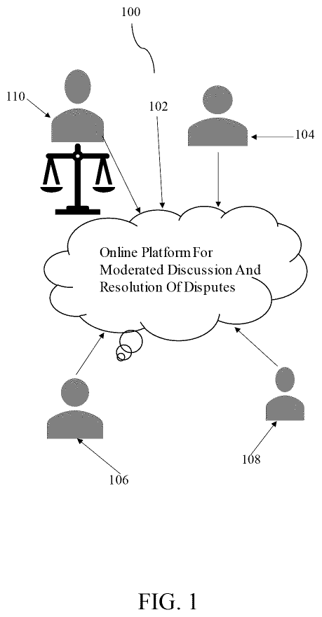

Referring to FIG. 1 the figure is a schematic diagram illustrating the general architecture and set up of the online platform 100 of the present invention. The online platform 100 of the invention is accessed by the stakeholders involved in the disagreement/dispute through the internet 102 using their computers, laptops, smart phones, or other smart devices. The figure shows the parties involved in the proceedings, namely, the user/fact creator 104 and the challengers 106 involved in the dispute, the fact court/courtroom, comprising the judge 110 and a third-party intervener/referee 108.

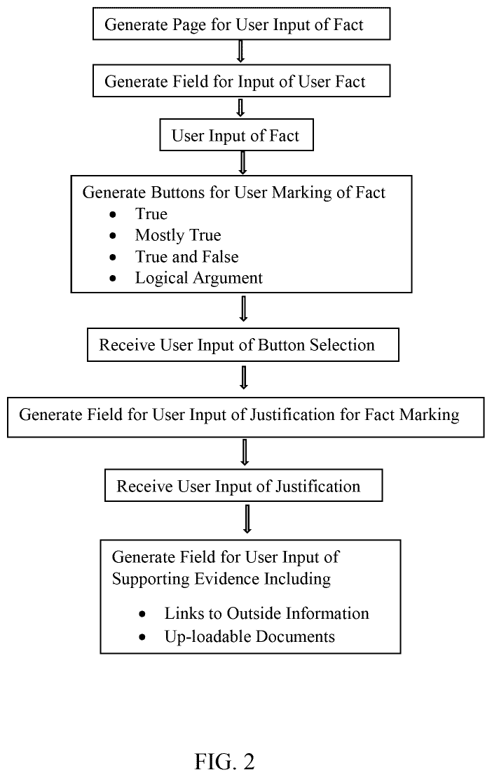

Referring now to FIG. 2, the process begins with a computer-generated page with an input field for accepting the input of a user-generated fact, statement, or other assertion. The system then receives the input of a user-generated fact, statement, or other assertion and generates buttons for marking the fact, statement, or other assertion in one of a number of optional ways. In certain embodiments, the user may be presented with options for marking the fact as true, mostly true, true and false, or marking it as a logical argument. However, it should be appreciated that in certain embodiments, the user may be presented with other options, including, but not limited to, marking the fact, statement, or assertion as false, mostly false, or partially true and partially false, or logical argument, with distinction as to the reasoning for such markings. The system then receives the user input of a selection of the marking of the fact, statement, or assertion. A field for user input of an explanation or justification for the marking of the fact, statement, or assertion is then generated and the system receives the input of the user justification for the marking of their fact, statement, or assertion with distinctions as to the reasoning for such markings. A field is generated to receive the user's input of supporting evidence, including links to supporting material and documents for upload to the system including, the user's description of uploaded material or data, or other identifiers for uploaded evidence, links, files, or other materials.

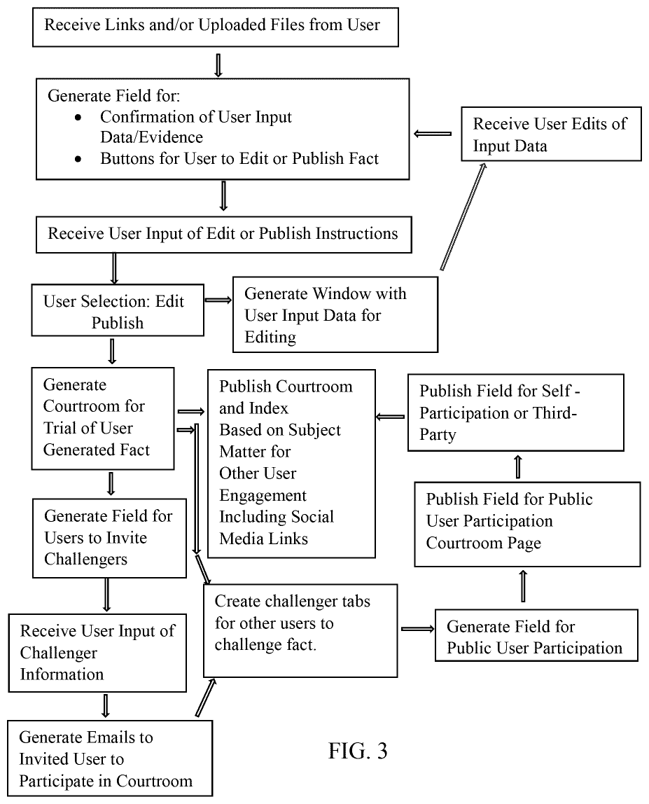

Referring now to FIG. 3, the process continues with the system receiving the user's input of links, uploaded files, and description. A field is generated for the user's links, uploaded files, and description. It should be appreciated that unlimited sets of pieces of evidence are allowed, each being represented by a large button/block, and each piece of evidence contains an associated description form indicating what the evidence is, and exactly where it is found in the attached or linked document. A field is generated for the user's confirmation of the fact, statement or assertion, and its supporting labels, evidence, links, or other uploaded files. The system then receives the user's input of confirmation of the input data and the instruction to publish the fact, statement, or other assertion. The system then generates a courtroom webpage for the user-generated fact, statement, or assertion, and its associated detailed explanation and pieces of evidence. The published courtroom webpage for the user's fact, statement, or assertion is then indexed by the system for searchability and to facilitate the engagement of other users or the sharing of the webpage, including through the use of other social media platforms, websites, apps, or programs.

Referring further to FIG. 3, the system generates a button for editing or changing of the fact, statement, or assertion. If the editing button is selected, the system generates a field for the user to edit the input data or to add or modify the input data. The system then receives the user's updates, edits, or changes, and then generates a field to confirm the updated data stream before receiving the user's publication instruction and updating the courtroom webpage with the newly received information or data. If the editing button is not selected or pressed, the system will do nothing and continue to monitor the button for inputs.

Once the system has received a publish command from a user, the system then generates a field for any user to invite other users to participate as challengers in the courtroom webpage. The system then receives the users' input of information for parties to invite and generate emails or other electronic messages to inform the other parties of their invitation to participate in the courtroom webpage discussion. The invitation issued by the system may be a generic invitation to participate, and the invited potential challenger may then elect whether or not to participate in the courtroom as a challenger. This process may be carried out in parallel with the process of publishing fields to the courtroom webpage for requests from third parties to participate in the courtroom webpage discussion. The system also generates three tabs for three challengers at the bottom of the courtroom page, with each tab representing a separate courtroom sub-page consisting of a debate section that allows unlimited rebuttal text boxes to appear as needed. Each tab allows one challenger to challenge the courtroom's argument/fact that the fact creator made, in order verify the veracity or falsehood of the user-generated fact, statement or assertion. The system may still incorporate a limit for the number of challengers who will participate in the courtroom webpage discussion. However, in certain embodiments, users may request permission for additional challenger positions to be allowed into the courtroom webpage discussion.

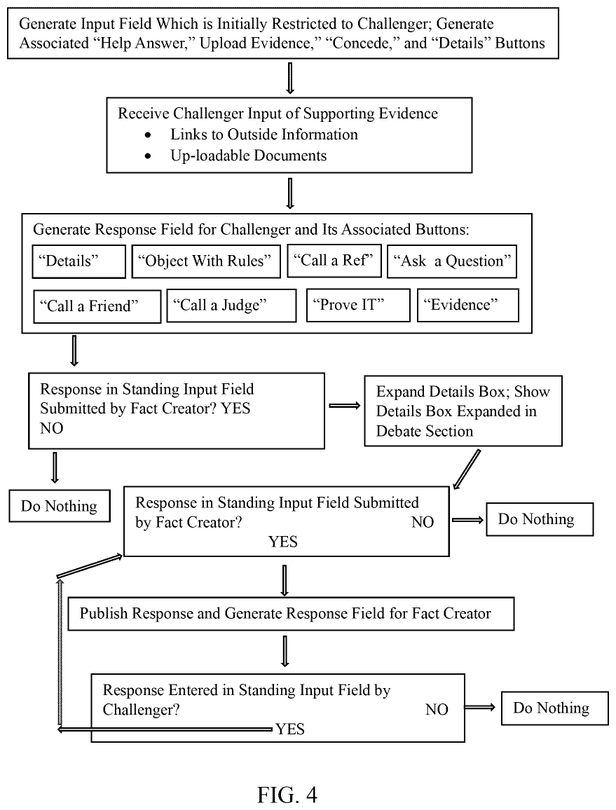

Referring to FIG. 4, the system generates a number of tabs or fields on the courtroom webpage for challengers to begin parallel discussions over the veracity or falsehood of the user-generated fact, statement, or assertion. In certain embodiments, the system may generate three tabs or fields for challenger discussions, but it should be appreciated that any number of discussions may be set by the system for any particular courtroom webpage. The system may also publish or generate a variety of buttons, links, or other user-actuatable elements on the courtroom webpage to facilitate the discussion and testing of the user-generated fact, statement, or assertion. For example, the system may publish or generate buttons such as Help Answer, Details, Upload Evidence, Prove It, Object with Rules, Ask a Question, Call a Friend, Call a Ref, Call a Judge, Concede, or other buttons as necessary for facilitation of the courtroom webpage discussion. The system may continuously monitor the courtroom webpage for activation of these buttons and respond as necessary.

Still referring to FIG. 4, the system may generate an input field restricted to a challenger. The system then receives the challenger's input of his or her argument, along with supporting evidence such as links to outside information, uploaded documents, and the challenger's evidence button containing descriptions of the uploaded documents or information. The system then generates a discussion field for each challenger where the challenger-input information is published in the debate section below, and a response field is generated for use by the user/fact-creator. The system then queries whether a response has been entered by the user/fact-creator. If the user/fact-creator has not entered a response, the system will do nothing and continue to monitor for user activity. If the user/fact creator has entered a response, the system publishes the response and generates a response field for the challenger. Note that the user submitting a response summarizes their response in the box that first shows. But by pressing the Details button below it, they may then write an expanded rebuttal. The purpose is to have a brief summary of the response for the sake of simplicity and clarity. When the rebuttal is sent below as a formal response, the summary answer box is the only one that shows, but the details button can be expanded there by users just as above in the input section, so that viewers might see the full response. The system then queries whether the challenger has entered a response. If the challenger has not entered a response, the system will do nothing and continue to monitor for user inputs. However, if the challenger has entered a response, the system then generates a response field again for the user/fact-creator. The system will continue this process, generating response fields as each opposing user enters a response and continues the discussion on the courtroom webpage. This process ensures that the user/fact-creator and challenger each respond to one another in a one-for-one conversation, allowing each to address the other's most recent comments or evidence in an orderly manner. This process may play out in parallel for each individual challenger participating in the courtroom webpage discussion. If responses are objected to, the debater who posted the response might have his or her response made null and void and forced to create a replacement response.

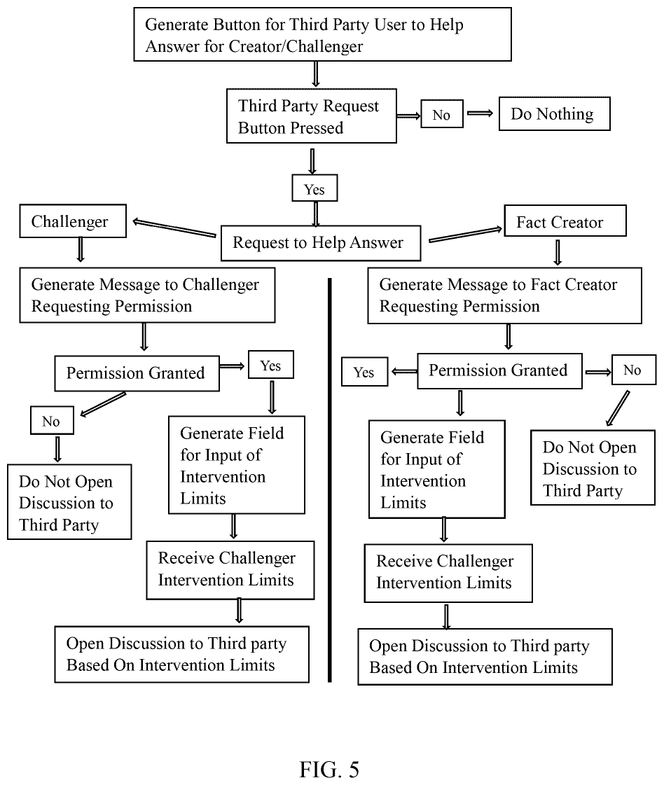

Referring now to FIG. 5, the system may also generate a button to allow a third party to request to assist in the discussion on behalf of the user/fact-creator or challenger. The system will then query this button for input from the third-party user. If the button is not pressed or activated, the system may do nothing and continue to monitor the button for inputs. If the button is pressed or activated, the system will query which party the third party has requested to intervene on behalf of. The system will then carry out one of two parallel processes depending on whether the requested intervention is on behalf of the challenger or the user/fact creator.

Continuing the reference to FIG. 5, the system will generate a message to the challenger or user/fact creator requesting permission to accept the third party's request to assist. The system will then query whether the challenger or user/fact creator has granted permission to the third party. If the challenger or user/fact creator does not grant permission, then the system will not open the discussion to the third party. If the challenger or user/fact creator does grant permission for the third party to intervene, the system will generate a field for the challenger or user/fact creator to input limits on the intervention of the third party. These limits may include time limitations, number of responses, or other limitations on the intervention of the third party before the discussion is returned to the challenger or user/fact creator. The system will also receive the challenger or user/fact creator intervention limits and open the discussion to the third party based on those input intervention limitations. In other embodiments, the third party is not given the ability to intervene, but to merely discuss the debate with the debater he or she is trying to help.

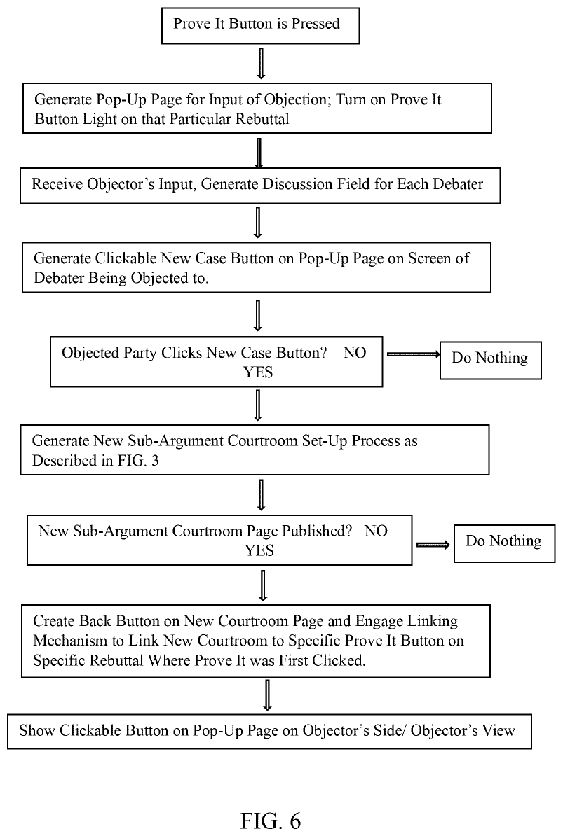

Referring to FIG. 6 the system may query whether the Prove It button has been activated. If the button has not been activated, the system will do nothing and continue to monitor the courtroom webpage for user activation of the button. If the Prove It button is activated, the system may then generate a field for a user to request additional proof of a statement made in the courtroom webpage discussions. Only the opposing debater who is participating in the discussions can have access to the Prove It button and ask the most recent respondent to Prove It. The system may then generate a new courtroom webpage in which the requested proof will be given. The assertion being proven thus becomes its own argument/fact in its own courtroom, while it retains the embodiment of a sub-argument or sub-courtroom in the courtroom from whence it originated. The system may also generate links between the original courtroom webpage and the sub-argument courtroom webpage to facilitate movement of users and viewers between the courtroom webpages.

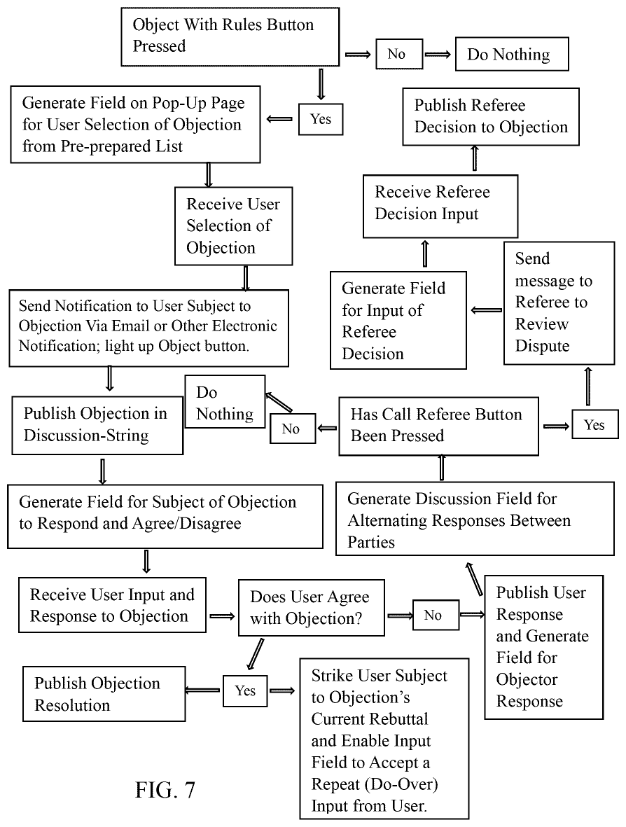

Referring now to FIG. 7, the system may query whether the Object with Rules button has been pressed or otherwise activated. If the button has not been pressed or activated, the system will do nothing and continue to monitor the button for user inputs or activity. If the button has been pressed, the system will generate a field for the user selection of an objection based on a pre-populated list of rules for which objections are available. The system will then receive the user's input of the selected objection and send a notification to the user which is the subject of the objection through email or other electronic notification, in addition to lighting up the Object with Rules button on that particular rebuttal in the courtroom. As with almost all courtroom functions, each function/button can be clicked and seen by the public. It should also be appreciated that in certain embodiments, the Objection button may be activated and engaged only by the user/fact creator and challenger while third parties will always be able to view the discussion and activities that took place between the two debaters.

Continuing the reference to FIG. 7, the system may generate a field for the subject of the objection to respond to the objection and to agree or disagree with the objection on any number of grounds, including, but not limited to, form, format, or because the objection is incorrect, or the subject of the objection has not violated a rule. The system may then query whether the subject of the objection has agreed or disagreed with the objection. If the subject of the objection agrees, the system may publish the objection resolution and strike the subject's response that faced objection, and compel the subject to submit a replacement rebuttal (by giving the subject control of the input box for a consecutive time). If the subject of the objection does not agree, the system may publish the subject's response and generate a field for the objector to respond. The system may also generate a discussion field for alternating responses between the parties. During this process, the system may monitor the Call a Ref button. If the button is not activated or pressed by one of the debaters, the system will do nothing and continue to monitor the button for activity. If the button is pressed, the system will send a message to a referee to review the objection and dispute between the parties. The system will then generate a field for the input of the referee's information, text, statements, or other information along with the referee's decision on the objection. The system will then receive the referee's decision and publish the referee decision on the objection to resolve the dispute.

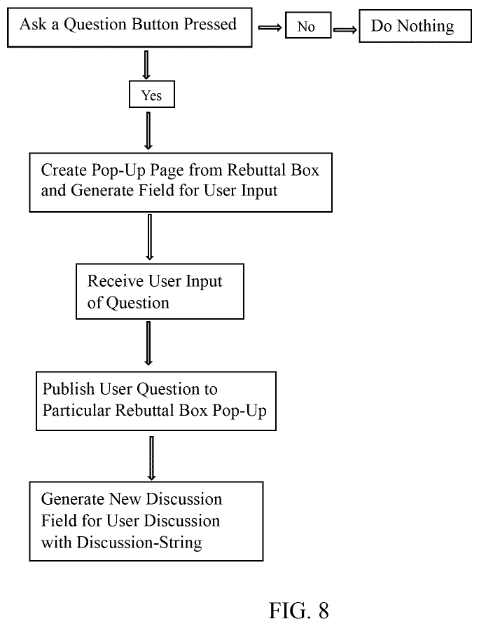

Referring now to FIG. 8, the system may also monitor the Ask a Question button for input or activation. If the Ask a Question button is not activated, the system will do nothing and continue to monitor the button for activity. If the Ask a Question button has been pressed, it will light up and the system may generate a field for the input of a user question regarding a discussion on the courtroom webpage. The system may then receive the user-input question and publish the question to the Ask a Question button's pop-up page. It should be appreciated that in certain embodiments, the Ask a Question functionality may be available only to participants in the discussion, for example the fact creator and the challenger.

Still referring to FIG. 8, the system may then generate a new discussion field for users to discuss the question in a chat or messaging function. The system will make the Ask a Question discussion publicly visible, as it does for all discussions except Call a Friend discussions. In certain embodiments, the system may include the question discussion in line with or otherwise within the larger courtroom webpage discussion.

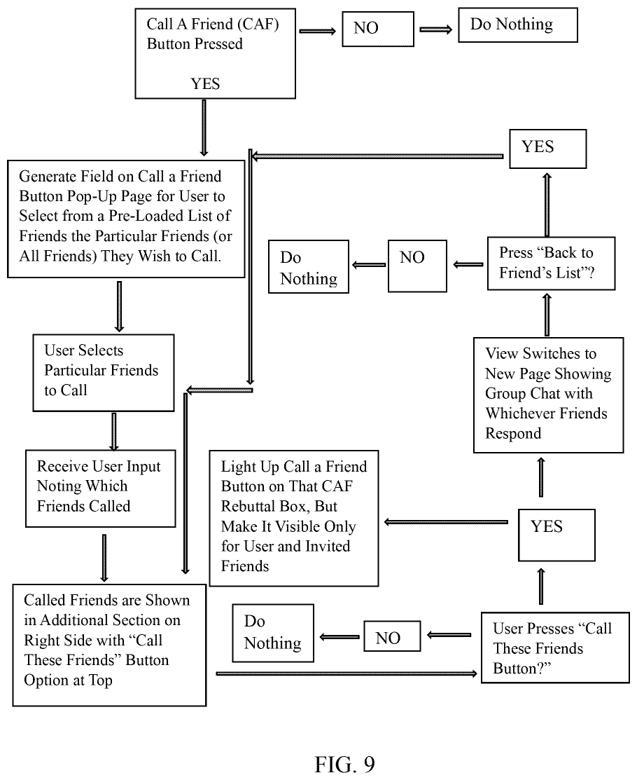

Referring now to FIG. 9, the system may monitor the Call a Friend button for activation. If the button is not activated, the system will do nothing and continue monitoring the Call a Friend button for activity. If the Call a Friend button is activated or pressed, the system will generate a field on the Call a Friend button pop-up page that lists all Fact Court friends the user has. The user will select a subset of friends, or all friends they want to call for help. Upon selecting the friends, the chosen friends appear in a new list to the right of the first list. Any friend can be removed at this point. When the final list is complete, the user can press the “Call These Friends” button. When they call the friends, the system may then generate an email or other electronic communication to the one or more third parties with a link and an invitation to participate in the courtroom webpage discussion. The third parties can find the illuminated Call a Friend button on the current rebuttal box in the courtroom (which the opponent cannot see) and click it to engage in a group chat with the user who called them. The user can always toggle back to the list of friends and select additional friends to call, and then toggle back (forward) to the chat page with the friends selected.

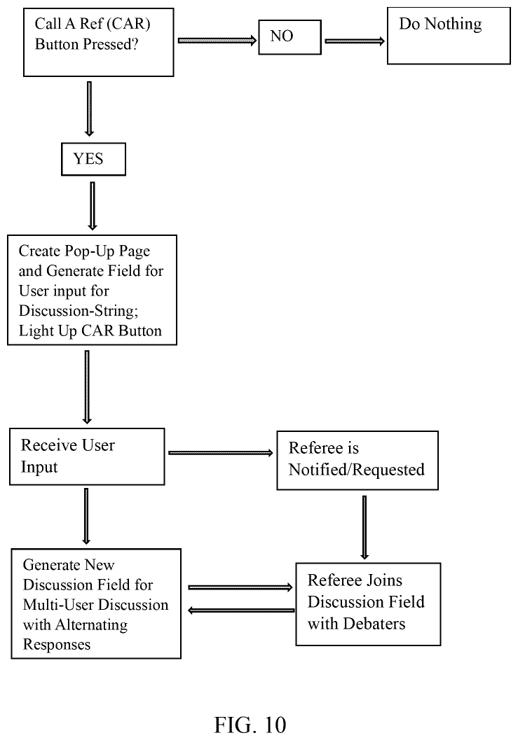

Referring now to FIG. 10, the Call a Ref button can be pressed at any time in order to call a Referee for assistance or to resolve disputes. Upon pressing the button, the user is asked whether he or she wants to call a referee. If the user chooses not to, nothing happens, and they may choose to press the Cancel button. If they do say yes and agree to call a referee, a referee appears in the multi-chat function where the user can discuss the problem with the referee, and the user's opponent is also present and can state any opposition.

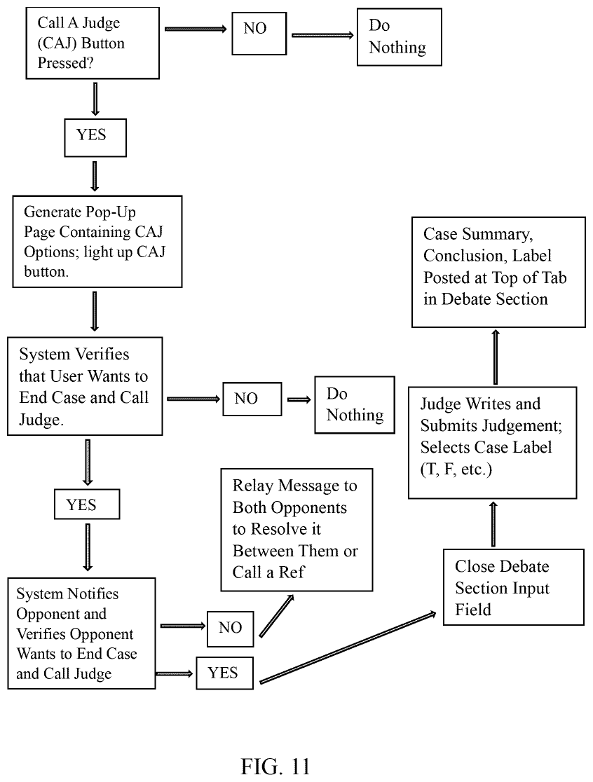

Referring to FIG. 11, the figure relates to the Call a Judge function of the system. During the course of activities and discussions on the courtroom webpage the system may monitor the use or activation of the Call a Judge button. If the button has not been pressed, the system will do nothing and continue to monitor the button for activity. If the button is pressed, the system will send a message to the judge to review a dispute or discussion—after first querying and receiving confirmation from both debaters that they wish to conclude their debate and allow the judge to rule on the winner. The system will also generate a field for the input of the judge's decision, including any supporting documents, evidence, or reasoning provided by the judge. The system may then receive this information from the judge and publish the judge's resolution about the case. It should be appreciated that the Call a Ref and Call a Judge buttons provide similar functionality in requesting a neutral third-party arbiter of disputes. However, the Call a Ref function may, in certain embodiments, refer to disputes over the rules of discussion, presenting evidence, and factual matters, while the Call a Judge button only involves having the judge decide who—if anyone—won their overall argument in the case.

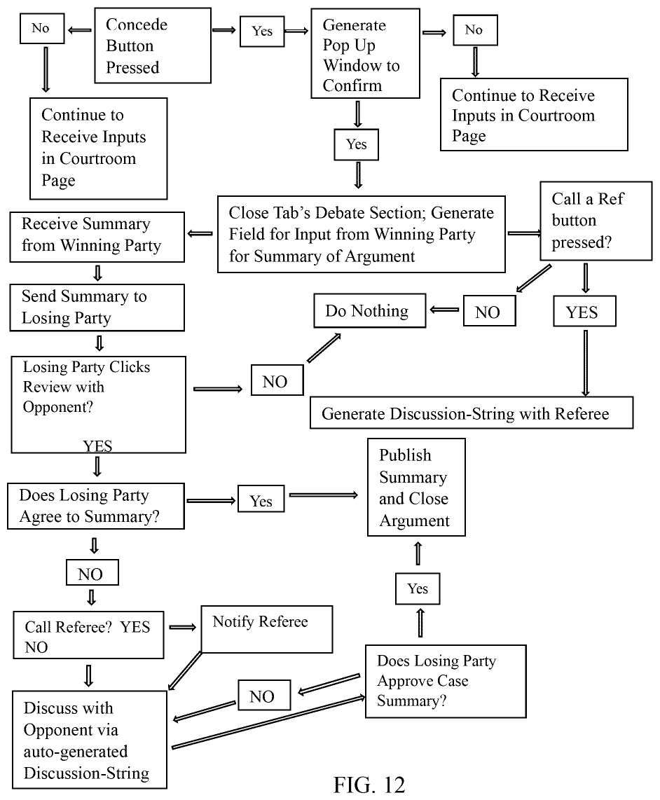

Referring now to FIG. 12, the system monitors the Concede button for activation or input. If the button is not pressed or activated, then the system may continue to monitor the button and continue to receive inputs and activity in the courtroom webpage discussion. If the concession button is activated, the system will generate a field or pop-up window requesting the party that activated the button to confirm whether or not the activating party is sure they wish to concede. If the system receives an instruction not to concede, the system will continue to receive inputs in the courtroom webpage discussions and monitor the concession button. If the system receives an instruction to concede, the system will notify both parties of the concession and close the debate and generate a new field in the place of the prior rebuttal response input field for input from the winning party to summarize the discussion and outcome. The system may then receive the summary from the winning party and send the summary to the losing party. The system will then generate or otherwise provide a field for the losing party to agree or disagree with the summary, as well as a field to discuss the summary and to call a referee. If the system receives an input that the losing party agrees to the summary, the system will publish the summary and close the courtroom webpage discussion.

If the system receives an input that the losing party does not agree with the summary, the system will generate a messaging function allowing the two parties to discuss, in an attempt to facilitate the generation of a summary that both parties may agree to. Should the two parties continue to disagree, either may call a referee to their messaging function to help resolve the conflict. The system will then generate a field for input of the agreed-upon case summary, including any comments, evidentiary support, or reasoning. The system will then publish the summary and close the argument.

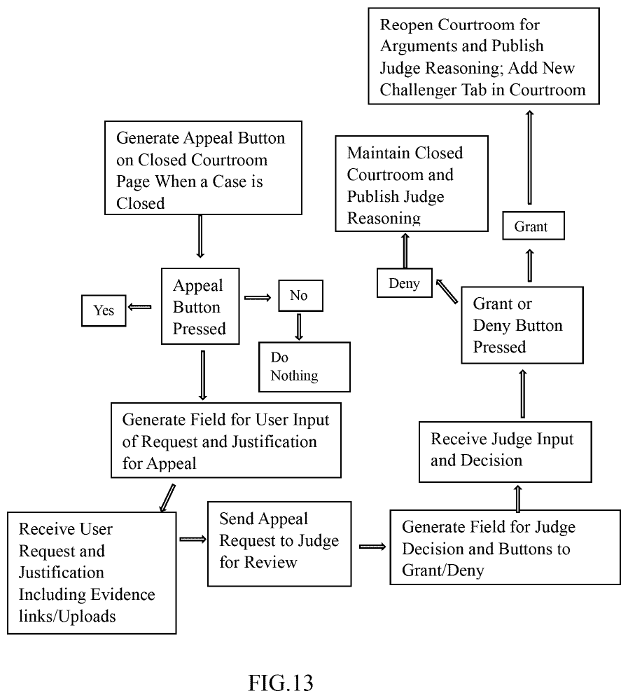

Referencing to FIG. 13, once a case closes, the system will then generate an Appeal button on the closed courtroom webpage. The system may then monitor the Appeal button for activation or other user activity. If the button is not activated, the system will do nothing. If the Appeal button is activated, the system will then generate a field for the activating user to input a request and justification for re-opening the courtroom webpage for further discussions. The system may then receive the user's request and justification for re-opening the courtroom webpage discussion, including any evidence, including links or user uploaded documents, explanations of the included evidence. The system will then send the appeal and associated information to a judge for review and generate a field for the judge's decision, any supporting evidence, comments, or reasoning, and a button to grant or deny the request. The system may then receive the input from the judge and the decision instruction. If the system receives an instruction to deny the request, the system will maintain the courtroom webpage in a closed condition and, in certain embodiments, may publish the reasoning for the denial to the courtroom webpage. If the system receives an instruction to grant the request, the system may reopen the courtroom webpage for discussion and, in certain embodiments, may also publish the reasoning from judge inputs for granting the appeal.

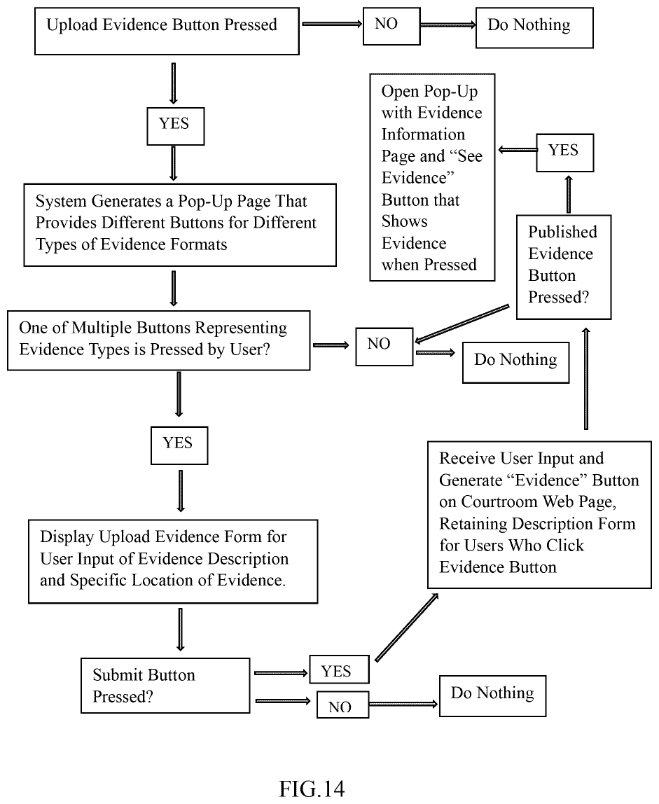

Referring to FIG. 14, the system has a thorough process for attaching evidence. When attaching evidence for both the initial fact creation and for individual rebuttals, the user presses the Upload Evidence button. If the button is not pressed or activated, then the system may continue to monitor the button and continue to receive inputs and activity in the courtroom webpage discussion. If the button is pressed, a large pop-up page opens that contains four buttons: “URL,” “Image,” “PDF,” And “Other Files.” Selecting any of these evidence types results in a new pop-up page which allows the user to attach that particular type of evidence. It also contains a form with four items which must be filled out that gives information about the evidence. The first item is the evidence name (what the user wants to call the evidence). The second is a brief description of the evidence, such as what the evidence source formally is (i.e., a report on something, an academic research paper, a web page, etc.). The third is the exact argument that the evidence supports in its current use. The fourth is the exact location in a document or web page where the specific proof can be found that proves the specific point listed on the form. Upon attaching the evidence and filling out the form, the user presses the Submit button. This results in an evidence button, with the title the user chose as the button name, being placed on the courtroom web page. The opposing debater and any third party can click on the evidence button. Upon doing so, the evidence information page opens so that the viewer can have full context about what the evidence is. They can then press the “See Evidence” button to view the evidence itself.

The Scoring Mechanism of the System of the Invention is as follows:

Each tab in the courtroom is marked as one of the following as a final score/label:

| | |
|---|---|
| 4 True | Debaters choose 0-4 |
| 3 Mostly True | Judge chooses 0-4 |
| 2 True and False | Ref chooses A, B] |
| 1 Indeterminable | |
| 0 False | |
| A Mistrial - Argument Creator | |
| B Mistrial - Challenger | |

The case label at the top of the courtroom page is marked according to the following algorithm:
The current (live) designation is whichever is the lowest of number 4-0, for whichever cases (tabs) are complete. If the case is not complete, it doesn't count.
Across all challengers, even additional ones:
If any tabs are A (mistrial), the designation is A (mistrial) unless there is a tab with 0 (false). If A is designated for a tab while no other challengers exist, the entire courtroom/case is closed.
If any tabs are B (mistrial), that tab is ignored in the assessment.
The system assigns the final judgement and label of the case as True, False, etc., based on the decisions by the debaters, the referee, the judge, or all three (across multiple tabs on a case). Each challenger tab can be assigned either True, Mostly True, True and False, Indeterminable, False, Mistrial-Argument Creator, and Mistrial-Challenger. True, Mostly True, True and False, Indeterminable and False are designated either by the winner (with the loser's approval), or by a judge. Mistrials are assigned when debaters refuse to accept a referee's decision. The overall case label at the top of the courtroom page will always be assigned with the worst/least positive label given on any challenger tab. If any of the challenger tabs were assigned False, that will be the label for the whole case. If True and False is assigned, it will be the label. If Mostly True is assigned, it will be the label. Otherwise, it will be True. However, if one of the challengers caused a mistrial, that tab will be ignored in the scoring. But if an argument creator was responsible for a mistrial, the overall case label at the top of the courtroom will be Mistrial-Argument Creator.

With reference to FIGS. 1-14, it should be appreciated that the above-described methodology may be carried out in parallel for multiple discussions within a single courtroom webpage. Furthermore, the system or method may be modified as desired or required to restrict the courtroom webpage discussions only to the user/fact creator and challenger, or to allow various levels of intervention to allow multiple parties to participate at once, or to restrict access only to two participants at any time to any particular discussion. The system may also be adapted or otherwise configured to maintain the courtroom webpage discussions and any closed courtroom with a full public record of all discussions, evidence, and arguments provided by any party to the courtroom webpage discussion. However, it should be appreciated that in certain embodiments, the system may provide private side discussions between the participating parties, such as in the case of the Call a Friend button. It should also be appreciated that any field generated by the system may be a pop-up box, text box, button, or other element of a graphical user interface capable of providing information to a user or receiving information or instruction from a user.

Further with reference to FIGS. 1-14, the system may provide added functionality in that, as individual courtroom webpage discussions are resolved, the system may maintain a library of established facts, statements, or assertions. The system may then allow for multiple-fact courtroom webpages wherein users may use prior courtroom cases/webpage discussion outcomes as the basis for more complex or developed facts, statements, or other assertions. In such multiple-fact courtrooms, instead of individual pieces of evidence such as documents and research papers being used as evidence, prior cases/courtrooms are used as evidence. These individual cases, or sub-facts, can be used as building blocks of evidence to support higher-level arguments. Multi-Facts are arguments/facts that are supported by other facts already established in other courtrooms. In these cases, the system may follow the same or substantially similar uploading method steps with the alteration that a user may not input evidence from outside links or provide user uploaded support. Rather, the system may provide fields and search functionality for a user to select from previously closed courtroom webpage discussions in place of outside evidence. The system may then maintain a growing body of established facts, statements, or assertions, and allow users to access these facts, statements, or assertions for support of more complex determinations of veracity or falsehood.

In general, the computing systems and/or devices described for this invention may employ any of a number of computer operating systems, including, but not limited to, versions and/or varieties of the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system and any of its variants, the Mac OSX and iOS operating systems distributed by Apple Inc. of Cupertino, California, the BlackBerry OS Distributed by Blackberry, Ltd. of Waterloo, Canada, and the Android operating system developed by Google, Inc. And the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java′, C, C++, Go, Python, MicroPython, Matlab, Simulink, Stateflow, Visual Basic, JavaScript, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc. A computer-readable medium (also referred to as a processor-readable medium) includes any non-transitory (e.g., tangible) medium that participates in providing data (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire, and fiber optics, including the wires that comprise a system bus coupled to a processor. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories, or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above and are accessed via a network in any one or more of a variety of manners. A file system may be accessible from a computer operating system and may include files stored in various formats. An RDBMS generally employs the Structured Query Language (SQL) in addition to a language for creating, storing, editing, and executing stored procedures, such as the PL/SQL language mentioned above. In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed limiting the scope of the invention.

Accordingly, it is to be understood that the above description of the invention is intended to be illustrative and not restrictive, and it is to be understood that the terminology which has been used is intended to be in the nature of words of description rather than of limitation. Many embodiments and applications other than the examples provided would be apparent to those skilled in the art upon reading the description. The scope of the invention should be determined with reference to any appended claims, along with the full scope of equivalents to which such claims are entitled. Many modifications and variations of the present disclosure are possible in light of the above teachings, and the disclosure may be practiced otherwise than as specifically described. It is anticipated and intended that future developments will occur in the arts discussed herein, and that the disclosed systems and methods will be incorporated into such future embodiments. All terms used in this description and in any applicable claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim or the description recites an explicit limitation to the contrary.

It should be appreciated that any of the components or modules referred to with regard to any of the present invention embodiments discussed herein, may be integrally or separately formed with one another. Further, redundant functions or structures of the components or modules may be implemented. Moreover, the various components may be in communication via wireless and/or hardwire or other desirable and available communication means, systems and hardware. Moreover, various components and modules may be substituted with other modules or components that provide similar functions.

It must also be noted that, as used in the specification and any appended claims, ranges may be expressed herein as from “about” or “approximately” one particular value and/or to “about” or “approximately” another particular value. When such a range is expressed, other exemplary embodiments include from the one particular value and/or to the other particular value. By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the disclosure including all modifications and equivalents and the appended claims.

What is claimed is:

1. A system for moderating and facilitating a resolution to disagreements and disputes between parties on a set of facts, said system comprising:
an online platform;
a user device to access said online platform through a graphic interface of said user device;
said user device comprising a server to communicate with said online platform, said server comprising a processor and a memory storing a set of executable instructions coupled to said processes, wherein the said set of executable instructions for said processor comprising:
generating a page for a user referred herein as a fact creator to input a set of facts on said online platform;
receiving an input from said fact creator on said set of facts;
generating a courtroom web page comprising a judge for trial of said fact creators said set of facts;
publishing said fact creators said set of facts on said courtroom webpage;
said courtroom webpage indexed by said system for searchability and to facilitate an engagement of users of other social media platforms, websites, applications (apps), or programs;
generating a field for said fact creator to invite challengers to dispute said fact creators said set of facts;
generating a means for third parties to intervene on behalf of said fact creator;
generating a means for third parties to intervene on behalf of said challengers;
generating a means for a referee to moderate said dispute between said fact creator and said challengers;
generating a field for input of said judge's decision on a veracity of said fact creators said set of facts; and
publishing said judge's comments and decision on said veracity of said fact creators said set of facts.

2. The system of claim 1 wherein, the system generates a field for the fact creator to mark the set of facts as true, false, mostly true, true and false and providing logical arguments and supporting evidence for justification of the facts by uploading supporting files, and links to outside information supporting the facts.

3. The system of claim 1 wherein, the system generates a field for the challengers to upload supporting evidence, documents and links to outsider information to dispute the fact creator's set of facts.

4. The system of claim 1 wherein, the system generates a standing input field having a debate section with buttons for the challengers, to object with rules, call a ref, ask a question, call a friend, call a judge, and challenge the fact creator to prove with evidence, the veracity of the fact creator's facts using a prove it button.

5. The system of claim 4 wherein, the fact creator submits a response to the challengers' queries in said standing input field and has the response published.

6. The system of claim 1 wherein, the system generates a field for third party intervention limits for the fact creator and the challengers.

7. The system of claim 6 wherein, the system receives the third-party input on behalf of the fact creator and the challengers including comments, evidence such as linked material or uploaded documents, and any tag information associated with such evidentiary materials.

8. The system of claim 4 wherein, the system generates a field for public user participation in the dispute between the fact creator and the challengers with the public users being able to use the debate section buttons of, object with rules, call a ref, ask a question, call a friend, call a judge, and challenge the fact creator to prove with evidence, the veracity of the fact creator's facts using the prove it button.

9. The system of claim 4 wherein, when the prove-it button is pressed, a popup page is generated with discussion field for each debating party and the generation of a sub-argument courtroom linked to the specific prove-it button.

10. The system of claim 4 wherein, if the object with rules button is pressed, the system will generate a field for the selection of an objection based on a pre-populated list of rules for which objections are available. The system will then receive an input of the selected objection and send a notification to the objecting user through email or other electronic notification.

11. The system of claim 4 wherein, if the ask a question button is pressed, the system will generate a field for the input of a user question regarding a discussion on the courtroom webpage. The system will then receive the user-input question and publish the question to the ask a question button's pop-up page.

12. The system of claim 4 wherein, if the call a friend button is activated or pressed, the system will generate a field on the call a friend button pop-up page that lists all fact court friends the user has. The user will select a subset of friends, or all friends they want to call for help. Upon selecting the friends, the user presses the “call these friends” button. The system will then generate an email or other electronic communication to the one or more friends selected with a link and an invitation to participate in the courtroom webpage discussion.

13. The system of claim 4 wherein, the call a ref button is be pressed at any time in order to call a referee for assistance or to resolve disputes. Upon pressing the call a ref button, a referee appears in the multi-chat function where the person calling the referee discusses the problem with the referee in the presence of the opponent who states their opposition.

14. The system of claim 4 wherein, if the call a judge button is pressed, the system will send a message to the judge to review the dispute or discussion after first querying and receiving confirmation from both debaters that they wish to conclude their debate and allow the judge to rule on the winner. The system will also generate a field for the input of the judge's decision, including any supporting documents, evidence, or reasoning provided by the judge. The system will then receive this information from the judge and publish the judge's resolution about the case.

15. The system of claim 1 wherein if the system receives an instruction from one of the parties to the dispute, to concede, the system will generate a field for input from the winning party to summarize the argument and discussion and send it to the losing party to agree or disagree with the summary.

16. The system of claim 15 wherein, the system generates a field for the losing party to agree or disagree with the summary, and if the losing party agrees to the summary, the system will publish the summary and close the courtroom webpage discussion.

17. The system of claim 16 wherein, the system generates a field for the losing party to appeal the judge's decision.

18. The system of claim 17 wherein, the system generates a field for the judge's decision to grant or deny an appeal from the losing party.

19. A computer implemented method for a moderated discussion and resolution to disputes between parties, said method comprising the steps of:
a) Input of a set of facts by a fact creator on an online platform;
b) said fact creator providing logical arguments and providing justification for the said set of facts through supporting evidence in the form of links to outside information and uploaded documents;
c) publishing said set of facts and supporting evidence for said set of facts on a courtroom webpage comprising a judge on said online platform;
d) indexing said webpage for subject matter and searchability, to facilitate an engagement of users of other social media platforms, websites, applications (apps), or programs, to join in a discussion on said online platform;
e) inviting one or more challengers to dispute said fact creator's set of facts;
f) inviting third party users to intervene or assist on behalf of said fact creator and said one or more challengers questioning a veracity of said fact creators said set of facts;
g) conceding by said fact creator or said challengers to said dispute
h) publishing said judge's reasoning and decision on a veracity of said fact creators said set of facts; and
i) granting, or denying an appeal by a losing party to said dispute by said judge.
